(19) United States
(12) Patent Application Publication
(10) Pub. No.: US 2015/0258482 A1
(43) Pub. Date: Sep. 17, 2015

(54) CENTRALIZED PURGING UNIT FOR ENGINE SUB-SYSTEMS

(71) Applicant: Caterpillar Inc., Peoria, IL (US)

(72) Inventors: Yongli Qi, Peoria, IL (US); Xinyu Ge, Peoria, IL (US)

(73) Assignee: Caterpillar Inc., Peoria, IL (US)

(21) Appl. No.: 14/726,639

(22) Filed: Jun. 1, 2015

(51) Int. Cl. B01D 46/00; F01N 3/023; B01D 53/94; F01N 3/22

(52) U.S. Cl. CPC B01D 46/0068; F01N 3/22; F01N 3/0233; B01D 53/9495

(57) ABSTRACT

A purging system for an engine system is disclosed. The engine system includes an engine and one or more to-be-purged sub-systems. The purging system includes a centralized purging unit with one or more compressed air sources to store and provide compressed air. The compressed air sources are fluidly communicable with each of the to-be-purged sub-systems. A control valve assembly includes one or more valves that are operably positioned between the compressed air sources and the to-be-purged sub-systems. A controller, which is in control communication with the control valve assembly, is configured to alternate the valves between an active state and an inactive state. This is to vary the fluid communication between the compressed air sources and at least one of the to-be-purged sub-systems. This alteration is based on a set of predefined threshold conditions.

### TECHNICAL FIELD

The present disclosure relates generally to purging units. More specifically, the present disclosure relates to a centralized purging system for one or more to-be-purged sub-systems associated with an engine.

### BACKGROUND

Engine systems, such as exhaust after-treatment systems, generally include multiple sub-systems. Some of the commonly known sub-systems include Exhaust Gas Recirculation (EGR) systems, Selective Catalytic Reduction (SCR) Systems, Diesel Particulate Filters Regeneration Device, or simply DPF regeneration device, and the like. Additional sub-systems to these systems may include EGR coolers that, based on a need, suitably cool the EGR system.

Engine after-treatment systems normally treat exhaust gases emitted from the engine. In general, exhaust gases include by-products of combustion, such as unburned fuel, particulate matter, sulfur compounds, water, forms of hydrocarbon compounds, and/or the like. Such by-products are residues that generally condense and deposit on the interior surfaces of components that are associated with the above noted sub-systems.

Because such deposits affect a general working of engine systems, each sub-system typically needs to be purged. A non-limiting example of a DPF regeneration device is described in U.S. Pat. No. 8,499,739, which discloses the purpose of purging the DPF regeneration device as to flush out impurities that may block an associated nozzle of the DPF regeneration device. Further, a non-limiting example of an SCR is described in U.S. Pat. No. 8,359,833, which discloses a purpose of purging the SCR as to flush out deposits formed from urea that can clog dosing components.

Similarly, residues from a coolant flow may be formed within EGR coolers. This may occur owing to relatively cold ambient conditions, low exhaust gas temperatures, and/or low exhaust gas flow rates through the EGR cooler. Such residual deposits that accumulate within the EGR cooler generally decreases the efficiency of the EGR cooler, and may lead to corrosion and deterioration of the components, and cause operational failures. Therefore, purging is performed. During a purging operation in EGR cooler, a stream of compressed fluid is generally delivered at a suitable pressure and temperature to flush out and purge the coolant out of EGR cooler.

However, in EGR coolers, purging may be performed for additional reasons. To this end, it may benefit some engine operating conditions and modes when a cooling imparted to an EGR flow is limited. In one example, purging the coolant from the EGR heat exchanger may prepare the EGR cooler for an uncooled mode of operation, such as in a Homogeneous Charge Compression Ignition (HCCI) mode of the engine. This mode offers the benefits of avoiding boiling of the coolant within the EGR cooler and increases a thermal resistance to heat loss from the EGR flow into the heat transfer medium flow path. The coolant is generally a liquid with a high thermal conductivity and high heat capacity, while the purge fluid is a gas with a thermal conductivity and heat capacity, which is lesser than that of the coolant. Accordingly, the purge fluid poses a higher thermal resistance to heat transfer out of the EGR flow compared to filling the heat transfer medium flow path with the coolant. This facilitates higher intake manifold temperatures for the HCCI mode.

With each sub-system specifying different purge requirements, such as, but not limited to a purge flow rate, purge-flow temperature, purge-flow pressure, and/or the like, it is common to install individual purging systems that correspond to each sub-system. Such additions may make the overall system bulky and relatively complex. Further, as stricter emission norms are promulgated, newer sub-systems may need to be added to an already bulky system. As a result, it may happen that individual purging systems need to be applied to each of the newly introduced sub-system. This may increase the system's bulkiness and complexity, increase cost, and may affect the engine system's overall efficiency.

U.S. Pat. No. 7,849,682 B2 is directed to an exhaust after-treatment device and to a fuel-powered burner for an exhaust treatment device. Although a discussion that pertains to the purging of the exhaust after-treatment is provided in this reference, no solution is supplied that addresses the bulkiness and complexity of the purging system, as multiple sub-systems associated with exhaust after-treatment may require multiple purging systems.

Accordingly, the system and method of the present disclosure solves one or more problems set forth above and/or other problems in the art.

### SUMMARY OF THE INVENTION

Various aspects of the present disclosure illustrate a purging system for an engine system. The engine system includes an engine and one or more to-be-purged sub-systems. The purging system includes a centralized purging unit with one or more compressed air sources, which store and provide compressed air. The compressed air sources are fluidly communicable with each of the to-be-purged sub-systems. The purging system includes a control valve assembly that includes one or more valves. The valves are operably positioned between the compressed air sources and each of the to-be-purged sub-systems. Further, a controller is included, which is in control communication with the control valve assembly. The controller is configured to alternate the valves between an active state and an inactive state to vary the fluid communication between the compressed air sources and at least one of the to-be-purged sub-systems. This alteration is based on a set of predefined threshold conditions.

Another aspect of the present disclosure discloses a purging system for an engine system. The engine system includes an engine and more than one to-be-purged sub-systems. The purging system includes a centralized purging unit that includes a compressed air rail that has fluid communication with one or more compressed air sources. This fluid communication is to store and provide compressed air. The compressed air rail is fluidly communicable with each of the to-be-purged sub-systems. A control valve assembly includes one or more valves. The valves are operably positioned between the compressed air rail and each of the to-be-purged sub-systems. The control valve assembly is configured to either block or effect the fluid communication between the compressed air rail and each of the to-be-purged sub-systems. The control assembly includes a relief valve that is configured to release compressed air when a pressure within the compressed air rail is above a threshold value. Further, the control valve assembly includes a quick connector valve configured to provide compressed air to an auxiliary sub-system. Further, a controller is in control communication with the control valve assembly, together with the relief valve and the quick connector valve. The controller is configured to alternate the one or more valves between an active state and an inactive state to vary a fluid communication between the compressed air sources and at least one of the to-be-purged sub-systems. This alteration is based on a set of predefined threshold conditions.

### BRIEF DESCRIPTION OF THE DRAWINGS

FIG. 1 is a schematic view of an exemplary purging system with a centralized purging unit, in accordance with the concepts of the present disclosure;

FIG. 2 is a detailed schematic of the purging system of FIG. 1, in accordance with the concepts of the present disclosure; and

FIG. 3 is a flowchart that explains an exemplary operation of the purging system of FIG. 1, in accordance with the concepts of the present disclosure.

### DETAILED DESCRIPTION

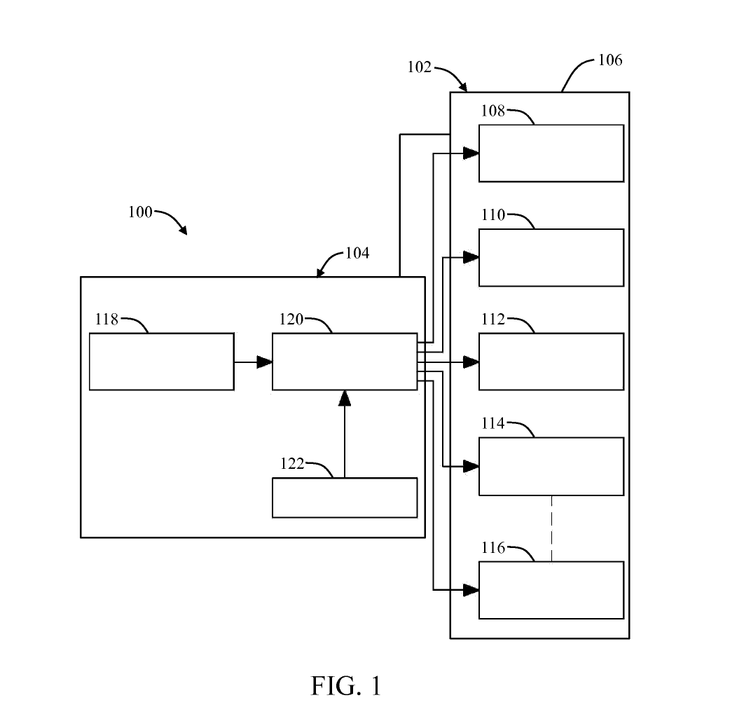

Referring to FIG. 1, an exemplary purging system 100 for an engine system 102 is shown. The purging system 100 includes a centralized purging unit 104, and the engine system 102 includes an engine 106. The engine 106 may be a conventional engine applied in variety of power-based applications, such as in construction machines, generator sets, and the like. As an example, the engine 106 is an internal combustion engine. The engine system 102 may include one or more ‘to-be-purged’ sub-systems associated with the engine's exhaust after-treatment. In the depicted embodiment, more than one ‘to-be-purged’ sub-systems are exemplarily shown. Namely, a first sub-system 108, a second sub-system 110, a third sub-system 112, and a fourth sub-system 114, are included. Each of these sub-systems may be interchangeably and respectively referred to as Exhaust Gas Recirculation (EGR) Cooler 108, Selective Catalytic Reduction (SCR) 110, Diesel Particulate Filter regeneration device, also referred to as DPF regeneration device 112, and Urea Lines 114. Further, the engine system 102 includes an auxiliary sub-system 116. This auxiliary sub-system 116 represents a number of additional sub-systems associated with the engine 106 that may require a purging operation, such as a maintenance tool. Collectively, these ‘to-be-purged’ sub-systems may be referred to as sub-systems 108, 110, 112, 114, and 116.

The centralized purging unit 104 is configured to fulfill the purge requirements of the engine system 102. The centralized purging unit 104 includes a compressed air source 118, a control valve assembly 120, and a controller 122.

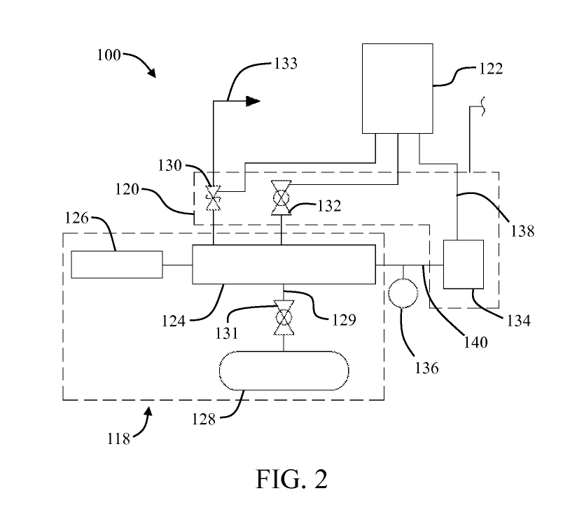

The compressed air source 118 is configured to combinedly pump and store compressed air. The compressed air source 118 is in fluid communication with each of the sub-systems 108, 110, 112, 114, and 116, to supply the stored compressed air to the sub-systems 108, 110, 112, 114, and 116. For ease in depiction, only a singular compressed air source 118 is shown. However, it may be contemplated that the compressed air source 118 works as an assembly that includes multiple units involving an air rail 124, an electric air compressor 126, and a variable volume accumulator 128 (FIG. 2). Compressed air may be maintained in either or each of the air rail 124, the electric air compressor 126, and the variable volume accumulator 128 (FIG. 2), above the atmospheric pressure. In general, the compressed air source 118 is a device that converts power, generated from the engine 106, and/or optionally from an electric motor, and/or recovered by a hydraulic accumulator, into potential energy. Such a conversion is attained by pumping ambient air into a generally smaller volume of the compressed air source 118. This results in increased air pressure within the compressed air source 118. The increased air pressure may be delivered to the sub-systems 108, 110, 112, 114, and 116.

The control valve assembly 120, or simply valve assembly 120, is operably positioned between the compressed air source 118 and each of the sub-systems 108, 110, 112, 114, and 116. The valve assembly 120 may include one or more valves that facilitate compressed air flow to each sub-system 108, 110, 112, 114, and 116, via fluid conduits (not shown), as customary. Such a flow occurs upon an identification of a purging requirement in one or more of the sub-systems 108, 110, 112, 114, and 116. The valve assembly 120 may include one or more flow-control devices that control the flow of compressed air from the compressed air source 118 to each sub-system 108, 110, 112, 114, and 116. A specified flow to each sub-system 108, 110, 112, 114, and 116, is pertinent since each sub-system 108, 110, 112, 114, and 116, may have different purge requirements. As an example, a purge requirement of the EGR cooler 108 may be different from the purge requirements of the SCR 110. Therefore, factors of purge requirements may vary from one sub-system to the other. Moreover, the temperature at which compressed air from the compressed air source 118 is delivered to the EGR cooler 108 may depend on a pressure and/or a flow rate at which the compressed air is being delivered. Similarly, other characteristic feature and combination of air delivery parameters, such as those related to a density of the delivered air, to each of the sub-systems 108, 110, 112, 114, and 116, may be controlled, as well.

The controller 122 is in control communication with the valve assembly 120. This is to enable control of the flow rate of the compressed air, for example. The controller 122 may regulate other characteristics of the delivered air, such as a volume of delivery, as well. More particularly, the controller 122 is configured to manage the one or more valves of the valve assembly 120 between an active state and an inactive state to vary a fluid communication between the compressed air source 118 and one or a combination of the sub-systems 108, 110, 112, 114, and 116. This alteration is managed based on a set of predefined threshold conditions, such as a computed efficiency of the sub-systems 108, 110, 112, 114, and 116. An identification of a purge requirement may necessitate the controller 122 to switch the valve assembly 120 into an active state.

As an option, the controller 122 may be the engine's electronic control module (ECM). However, the controller 122 may be a stand-alone microprocessor-based device. The controller 122 may be operatively connected to the valve assembly 120 via cabled links 138. The controller 122 may include a set of volatile memory units, such as Random Access Memory (RAMs)/Read Only Memory (ROMs), which include associated input and output buses. More particularly, the controller 122 may be envisioned as an application-specific integrated circuit, or other logic devices, which provide controller functionality, and such devices being known to those with ordinary skill in the art. In an exemplary embodiment, the controller 122 may form a portion of one of the engine's existing control units, such as a safety module, fuel regulation module, and/or the like. The controller 122 may be accommodated within panels or portions of the engine system 102 from where the controller 122 remains accessible for service and repairs.

The controller 122 may include a memory (not shown) where data related to a flow of compressed air corresponding each sub-system 108, 110, 112, 114, and 116, is stored. For example, a flow of compressed air to the EGR cooler 108 during purging may require a degree of flow rate, pressure, temperature, and other characteristics, which may be unique to requirements of the EGR cooler 108 alone. Similarly, data pertaining to other sub-systems may be different, and once determined, those data may be stored within the memory (not shown) as well.

Referring to FIG. 2, further details of the purging system 100 are described. Notably, the illustration depicts a preferred mode of operation of the purging system 100. However, embodiments of the present disclosure need not be seen as being restricted to this depicted embodiment alone. FIG. 2 is described in conjunction with FIG. 1.

As shown and noted above, compressed air may be stored within one or a combination of the air rail 124, the electric air compressor 126, and the variable volume accumulator 128. Similarly, the valve assembly 120 may include one or more valves. More particularly, the valve assembly 120 includes a relief valve 130, a quick connector valve 132, and a flow valve 134. Given the control communication of the controller 122 with the valve assembly 120, the relief valve 130 and the quick connector valve 132 are in control communication with the controller 122, as well. Additionally, the purging system 100 also includes a pressure sensor 136, as illustrated.

The air rail 124 is a compressed air rail, which is generally a chamber with a common rail structure. The air rail 124 is fluidly connected to the electric air compressor 126 and the variable volume accumulator 128 (or the compressed air sources). The air rail 124 is configured to store compressed air generated by the electric air compressor 126. The air rail 124 is also configured to store the compressed air released from the variable volume accumulator 128 when the compressed air in the variable volume accumulator 128 reaches a threshold. In that manner, compressed air may be received by the air rail 124 from the electric air compressor 126, as the electric air compressor 126 is generally operatively coupled to a generator (not shown), sourced from the engine 106. The air rail 124 stores the energy of the compressed air obtained from the electric air compressor 126, and this energy is provided to purge the sub-systems 108, 110, 112, 114, and 116, as the stored air is gradually depressurized.

The variable volume accumulator 128 acts as an additional source via which energy may be recovered and compressed air may be delivered to the air rail 124, and then to one or more of the sub-systems 108, 110, 112, 114, and 116. In general, the variable volume accumulator 128 may be a pressure reservoir in which a compressible fluid, such as air, is stored under pressure by an external means. In so doing, compressed air may be maintained substantially pressurized in the air rail 124. The variable volume accumulator 128 is connected to the air rail 124 via a fluid line 129 that includes a valve 131. The valve 131 may be a check valve that ensures establishment and maintenance of a threshold pressure within the the variable volume accumulator 128, and that the pressure is released upon a requirement.

The pressure sensor 136 is operably connected to purge lines 140 of the purging system 100. The pressure sensor 136 may monitor the pressure of the compressed air that is delivered to the one or more sub-systems 108, 110, 112, 114, and 116. The pressure sensor 136 is configured to communicate to the controller 122 the requirement to increase or decrease the level of pressure of purging air. In turn, the controller 122 may vary the fluid communication between the compressed air source 118 and the sub-systems 108, 110, 112, 114, and 116, by means of the flow valve 134. Moreover, multiple other sensor types may be positioned relative to the purge lines 140 to determine and deliver one or more sets of data that factors an effective purging operation. As an example, temperature sensors (not shown) may measure the temperature at which the compressed air is being delivered. Further, flow-rate sensors may detect the rate at which the compressed air flows. Each such detection factor may be delivered to the controller 122.

The flow valve 134 may facilitate a delivery of compressed air to the sub-systems 108, 110, 112, 114, and 116. The flow valve 134 may be a series of 2-way valves or a combination of 2-way valves and 3-way valves. According to an aspect of the present disclosure, the flow valve 134 may be toggled directly between a fully closed condition and a fully open or a wide-open condition. According to another aspect of the present disclosure, the flow valve 134 may effect proportional control of the flow resistance, or effective flow area between one of the sub-systems 108, 110, 112, 114, and 116, and the air rail 124. Effectively, the flow valve 134 of the valve assembly 120 is operably positioned between the air rail 124 and each of the sub-systems 108, 110, 112, 114, and 116.

The flow valve 134 may be configured to receive the compressed air from the compressed air source 118 and regulate a flow of the compressed air to the sub-systems 108, 110, 112, 114, and 116. This allows the flow valve 134 of the valve assembly 120 to effect different states of fluid communication between the compressed air source 118 (or the air rail 124), and each of the sub-systems 108, 110, 112, 114, and 116. As an example, the flow valve 134 may affect fluid communication of the compressed air source 118 to the EGR cooler 108. At the same time, a blockage of fluid communication of the compressed air source 118 with the SCR 110 may be affected. In so doing, compressed air with an appropriate pressure characteristic may be delivered to the EGR cooler 108, to execute a purging operation within the EGR cooler 108. Similarly, the compressed air at a different pressure may effect fluid communication with the SCR 110 and block fluid communication with the EGR cooler 108. Therefore, the flow valve 134 may selectively vary, block, and affect fluid communication, between the compressed air source 118 and each of the sub-systems 108, 110, 112, 114, and 116. In this manner, delivery of the compressed air that corresponds to each sub-system 108, 110, 112, 114, and 116, may be uniquely characterized to meet the specific requirements of each sub-system 108, 110, 112, 114, and 116.

The relief valve 130 is configured to provide relief to a threshold pressure within the purging system 100 (or the air rail 124) by venting surplus pressure to an ambient via an exit 133, when a pressure of the compressed air is above a threshold value. The quick connector valve 132 facilitates connection of the purging system 100 and a delivery of compressed air to additional sub-systems of the engine system 102, such as the auxiliary sub-system 116. Each of the valves 130, 132, and 134, are fluidly connected to the air rail 124. Moreover, each of the valves 130, 132, and 134, may either be hydraulically, pneumatically or electrically activated and deactivated. Such activation and deactivation may be controlled by the controller 122.

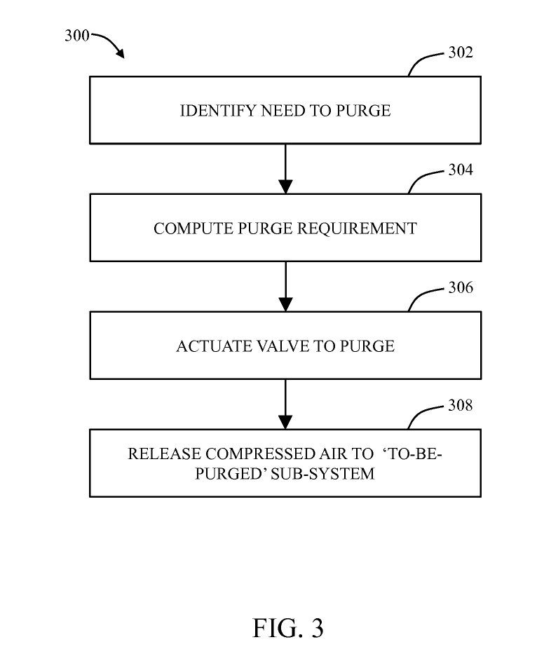

Referring to FIG. 3, an exemplary method of operation of the aspects of the present disclosure is explained. This exemplary method is described by a flowchart 300. FIG. 3 is described in connection with FIGS. 1 and 2.

At step 302, a need to purge is identified. The timer set within the controller 122 may aid in this identification, for example. The timer may be set to periodically identify and tabulate data corresponding to the sub-systems 108, 110, 112, 114, and 116, and to determine which of the sub-systems 108, 110, 112, 114, and 116, requires a purging operation. As the timer may record when a last purging operation was performed in any of the sub-systems 108, 110, 112, 114, and 116, it may be identified when a next purging is required. Another factor that may establish such an identification is the efficiency of the sub-systems 108, 110, 112, 114, and 116. For example, if one of the sub-systems 108, 110, 112, 114, and 116, is under-performing, it may be identified that the ineffective sub-system needs purging. Both factors of efficiency and periodicity may be set as threshold conditions of purge identification, although multiple other factors may be contemplated. Alternatively, an identification may be determined manually at the time of maintenance and/or service, for example. In general, this stage accompanies an activation of the purging system 100. The method proceeds to step 304.

At step 304, the controller 122 computes the purge requirement in the identified sub-system. Purge requirement may be based upon the purposes and operation requirements of sub-systems 108, 110, 112, 114, and 116. Accordingly, it may happen that a compressed air with a specified pressure, temperature, and flow rate, is delivered to one of the 108, 110, 112, 114, and 116. The method proceeds to step 306.

At step 306, the controller 122 actuates and/or activates the flow valve 134 to a degree that is based on the retrieved preset purge requirement parameter. The method proceeds to end step 308.

At end step 308, the air rail 124 deactivates the fluid communication between the air rail 124 and the to-be-purged sub-system. The end step 308 continues until the purging operation is required, which may also be established as a preset parameter. The purging process halts when the chosen sub-system is relived of the impurities that may have affected an associated operation.

### INDUSTRIAL APPLICABILITY

In operation, as the engine system 102 operates, impurities and other particulate matter may be deposited over the interior surfaces of one or more of the sub-systems 108, 110, 112, 114, and 116. As a result, the purging system 100 identifies the need to purge at least one of the sub-systems 108, 110, 112, 114, and 116. This need may be based on the efficiency of the sub-systems 108, 110, 112, 114, and 116, which may deteriorate over a period. Alternatively, the need may also be found upon a periodic operational course.

More particularly, there may be varied purposes for purging the engine system 102. When a multimode combustion engine operates in Homogeneous Charge Compression Ignition (HCCI) mode, it is desirous to purge the coolant out of the EGR cooler 108. Once a need to purge is identified, the controller 122 determines the purge requirement in the sub-system that requires to be purged. This requirement may vary from the amount of air that needs to be delivered to the rate of flow of air that needs to be maintained, while delivering air. Once a quantity and the flow rate of the compressed air corresponding a particular sub-system, among the sub-systems 108, 110, 112, 114, and 116, is determined (or retrieved from preset parameters), the controller 122 actuates the flow valve 134 and releases the compressed air to the ‘to-be-purged’ sub-system. This quantity and the flow rate of the compressed air, alongside other characteristic data, such as a temperature of the compressed air, forms predefined threshold conditions. The predefined threshold conditions may be stored as data within the memory of the controller 122, and may be retrieved upon each purging event, as already noted.

Notably, the controller 122 may be configured to receive sensed pressure signals from the pressure sensor 136. Subsequent to this receipt, the controller 122 processes the received signal and converts the signal into a feedback-specific format, which is compatible for a delivery to one or more of the relief valve 130, the quick connector valve 132, and the flow valve 134, for an affiliated operation. An affiliated operation of the flow valve 134 may involve a variation in the fluid communication between the sub-systems 108, 110, 112, 114, and 116, and the compressed air source 118.

As the purging system 100 is a centralized system, minimum space is used for the engine system 102. Further, fuel losses are mitigated and the complexity associated with the incorporation of a purging system with the engine system 102, is reduced. As separate sub-systems may also need to be regularly purged, the purging system 100 provides a means to fluidly connect those additional sub-systems to the centralized purging unit 104, as well.

It should be understood that the above description is intended for illustrative purposes only and is not intended to limit the scope of the present disclosure in any way. Thus, those skilled in the art will appreciate that other aspects of the disclosure may be obtained from a study of the drawings, the disclosure, and the appended claim.

What is claimed is:

1. A purging system for an engine system, the engine system including an engine and one or more to-be-purged sub-systems, the purging system comprising:
a centralized purging unit, including:
one or more compressed air sources to store and provide compressed air, the one or more compressed air sources being fluidly communicable with each of the one or more to-be-purged sub-systems;
a control valve assembly including one or more valves, the one or more valves being operably positioned between the one or more compressed air sources and each of the one or more to-be-purged sub-systems; and
a controller in control communication with the control valve assembly and configured to alternate the one or more valves between an active state and an inactive state to vary fluid communication between the one or more compressed air sources and at least one of the one or more to-be-purged sub-systems, the alteration being based on a set of predefined threshold conditions.

2. A purging system for an engine system, the engine system including an engine and more than one to-be-purged sub-systems, the purging system comprising:
a centralized purging unit, including:
a compressed air rail having fluid communication with one or more compressed air sources to store and provide compressed air, the compressed air rail being fluidly communicable with each of the more than one to-be-purged sub-systems;
a control valve assembly including one or more valves, the one or more valves being operably positioned between the compressed air rail and each of the more than one to-be-purged sub-systems,
wherein the control valve assembly is configured to either block or effect the fluid communication between the compressed air rail and each of the more than one to-be-purged sub-systems;
wherein the control valve assembly includes a relief valve that is configured to release compressed air when a pressure within the compressed air rail is above a threshold value;
wherein the control valve assembly includes a quick connector valve configured to provide compressed air to an auxiliary sub-system; and
a controller in control communication with the control valve assembly, the relief valve, and the quick connector valve, and configured to alternate the one or more valves between an active state and an inactive state to vary fluid communication between the one or more compressed air sources and at least one of the more than one to-be-purged sub-systems, the alteration being based on a set of predefined threshold conditions.
